(19) United States
(12) Patent Application Publication
(10) Pub. No.: US 2009/0129390 A1
(43) Pub. Date: May 21, 2009

(54) Method for transferring a stream of at least one data packet between first and second electric devices and corresponding device

(75) Inventors: Giuseppe Maruccia, Grenoble (FR); Riccardo Locatelli, Grenoble (FR); Lorenzo Pieralisi, Seyssins (FR); Marcello Coppola, Sassenage (FR); Michele Casula, Oristano (IT); Luca Fanucci, Pistoia (IT); Sergio Saponara, Pisa (IT)

Correspondence Address: DOCKET CLERK, P.O. DRAWER 800889, DALLAS, TX, 75380, US

(73) Assignees: William A. Munck, Dallas, TX (US); STMicroelectronics (Grenoble) SAS, Grenoble (FR)

(21) Appl. No.: 12/313,364

(22) Filed: Nov. 19, 2008

(30) Foreign Application Priority Data
Nov. 20, 2007 (EP) 07121139.5

(51) Int. Cl. H04L 12/56

(52) U.S. Cl. 370/392; 370/389

(57) ABSTRACT

Systems and methods for transferring a stream of at least one data packet between a first electronic device and second electronic device through a network-on-chip are disclosed. These systems and methods can comprise storing data packets in memory means provided in a network interface and transferring data packets from the memory means to the second electronic device. Packets can be transferred from the memory means after a quantity of packets is stored in the memory means, the quantity of packets being determined according to a value of a control parameter.

### CROSS-REFERENCE TO RELATED APPLICATIONS

The present application is related to European Patent Application No. 07 121 139.5, filed Nov. 20, 2007, entitled “METHOD FOR TRANSFERRING A STREAM OF AT LEAST ONE DATA PACKET BETWEEN FIRST AND SECOND ELECTRONIC DEVICES AND CORRESPONDING DEVICE”. European Patent Application No. 07 121 139.5 is assigned to the assignee of the present application and is hereby incorporated by reference into the present disclosure as if fully set forth herein. The present application hereby claims priority under 35 U.S.C. §119(a) to European Patent Application No. 07 121 139.5.

### TECHNICAL FIELD

The invention relates, in general, to on-chip communication architectures and is in particular directed to the transmission of data from a source electronic device to a destination electronic device belonging to separate interconnection systems such as on-chip communication architectures.

### BACKGROUND

For example, generally speaking, the invention is thus directed to the communication of data through a so-called network-on-chip system between electronic devices each connected to an on-chip bus.

As a matter of fact, researchers have recently proposed the network-on-chip concept (NoC) to overcome the limitations relating to the huge efforts necessary to adequately design on-chip communication systems.

NoC aims at providing scalable and flexible communication architectures with suitable performances. NoCs are based on a packet switched communication concept and are mainly composed of three NoCs modules, namely: a router, a network interface (NI) and a link.

As concerns the data format, data transferred within a NoC are generally composed of data packets having a header and a payload. The header contains control data for controlling data transfer and is thus responsible for carrying all the information required for performing communication, whereas the payload contains the actual information to be transmitted.

Conversely, data packets transmitted over an on-chip bus are based on specific transaction protocols. For example, the so-called “ST bus” developed by the applicant is based on a “ST bus protocol type 3” using a separate request channel and a response channel to provide communication between an initiator module and a target module.

On on-chip buses, data packets may be transmitted using two separate channels, namely a first channel provided to transfer control data and a second channel provided to transfer actual data to be used by the destination electronic device.

To provide communication between electronic devices connected to an on-chip bus, conversion of data must be carried out when data are transferred through a NoC.

Usually, network interfaces are in particular provided to provide communication with a NoC in order to convert data from one format to another.

For data conversion, the network interfaces are each provided with a memory means in which are stored the packets produced by the network interface before injection in the NoC, the stored packets having a header, comprising control data used to control transfer of data, and a payload, comprising data to be transferred. For example a payload is present in request packets when a store operation is performed.

Packet injection is then realized from data stored in the memory means.

### SUMMARY

In view of the foregoing, it is hereby proposed a method for transferring data through a network-on-chip permitting in addition to reduce latency and, as the case may be, to check integrity of data before forwarding.

In particular, it is hereby proposed a method for transferring data through a network-on-chip permitting to reduce latency and, as the case may be, to check integrity of data transferred in a form a stream of data packets.

Accordingly, according to one approach, it is hereby proposed a method for transferring a stream of at least one data packet between a first electronic device and a second electronic device through a network-on-chip, comprising:

storing data packets in memory means provided in a network interface; and

transferring data packets from the memory means to the second device.

According to a general feature of this method, packets are transferred from the memory means after a quantity of packets is stored in the memory means, said quantity being determined according to a value of a control parameter.

Accordingly, this method provides a so called “store and forward” mechanism in which a predetermined number of data packets are stored in memory means before being transferred to a destination device.

According to one embodiment, data packets are transferred when said memory means are full.

According to another feature, the method comprises in addition comparing a write pointer and a read pointer for said memory means and transferring said packets when the result of this comparison indicates that packets have been stored in the memory means.

According to a further feature, packets comprising a header and a payload, said header is stored in a header memory and said payload is stored in a payload memory. The value of the header memory write pointer is updated when said quantity of packets have been stored in the memory means.

In one embodiment, the method is intended to transfer a stream of one data packet. The value of the header memory write pointer is thus updated when the last data of said data packet has been stored in the memory means.

The method may also comprise, in addition, detecting a first flag in said packet, indicating the last data of said packet.

The method can also be used for transferring a stream of at least two packets. The value of the header memory write pointer is updated for each packet to check, for each packet, the value of a second flag indicating the last packet or an end of packet stream of said stream of data packets.

In one embodiment, the method comprises, in addition, accessing the header memory for scanning each packet header stored in the memory means using an auxiliary pointer updated after each packet storage to detect, in said packet header, said second flag, and authorizing the packets transferring when the memory means are not empty, after detection of said second flag.

The method may thus comprise, in addition, detecting a flag in each header indicating whether said packet comprises a payload.

For example, the header memory write pointer is updated when the second memory is full.

Data may in addition be transferred when the first or the second memory is full.

According to another aspect, it is in addition proposed a device for transferring a stream of at least one data packet between a first electronic device and a second electronic device through a network-on-chip.

This device comprises memory means for storing data packets and causing a transfer of packets after a quantity of packets is stored in the memory means, said quantity of packets being determined according to the value of a control parameter.

According to another feature of this device, the memory means comprise a header memory for storing a header of each packet comprising control data for controlling data transfer, and a payload memory for storing a payload comprising actual data to be transferred.

According to another feature, the device comprises in addition, means for detecting a first flag in said memory means, indicating the last data of said packet, and means for updating a write pointer for the memory means after detection of said first flag.

According to yet another feature, the device comprises in addition, means for detecting a full status of the second memory and means for updating the write pointer after detection of said full status.

It may also comprise means for comparing the write pointer and a read pointer for said memory means to cause reading of the memory means when the result of the comparison indicates that packets have been stored in the memory means.

It may in addition comprise means for checking the value of a second flag indicating the last packet of said stream of data packets to cause reading of the memory means when said last packet is stored in the memory means.

For example, the device further comprises means for detecting a full status of the first and second memories to cause reading of said memory means after detection of a full status of either the first memory or the second memory.

It is in addition proposed an electronic equipment comprising a chip having a network-on-chip and a network interface for transferring a stream of at least one data packet between a first electronic device and a second electronic device through the network-on-chip, wherein said network interface comprises a device as defined above.

Other technical features may be readily apparent to one skilled in the art from the following figures, descriptions and claims.

### BRIEF DESCRIPTION OF THE DRAWINGS

For a more complete understanding of this disclosure and its features, reference is now made to the following description, taken in conjunction with the accompanying drawings, in which:

FIG. 1 illustrates the general context of the method and device for transferring stream of data packets between the first and second electronic devices;

FIG. 2 shows schematically the architecture of a network interface implemented to provide communication between a network-on-chip and an on-chip bus;

FIG. 3 illustrates the block diagram organization of a network interface as far as a request path is concerned;

FIG. 4 illustrates the block diagram organization of a network interface as far as a response path is concerned;

FIG. 5 illustrates the generation of an empty signal used to trigger reading of the first memory when the store and forward mechanism is not active;

FIG. 6 illustrates the generation of an empty signal used to trigger the reading of the first memory when the store and forward method mechanism is active on one packet basis; and

FIG. 7 illustrates the generation of the empty signal used to trigger the reading of the first memory when the store and forward mechanism is active on a burst of packet basis.

### DETAILED DESCRIPTION

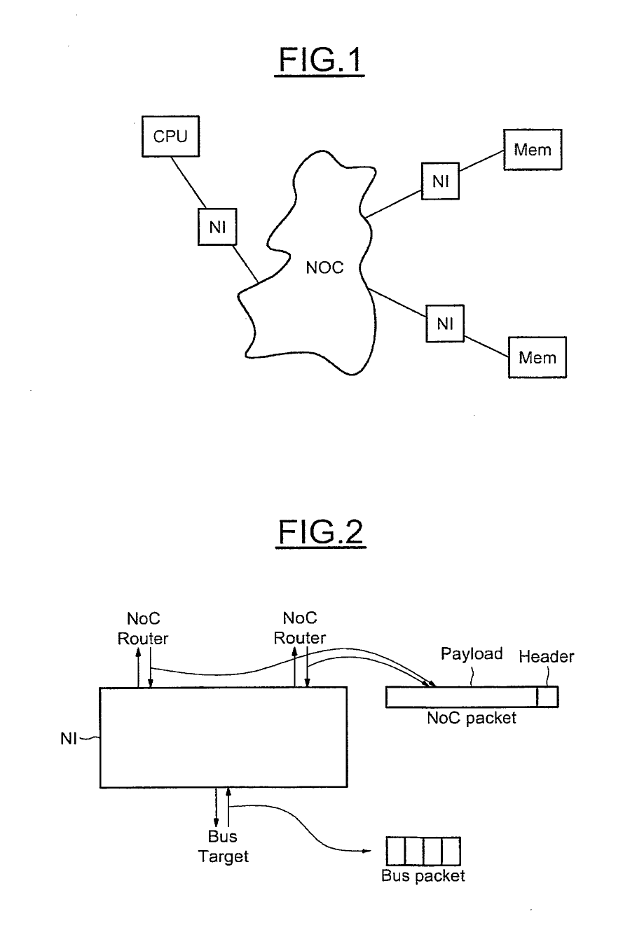

Reference is made to FIG. 1, showing an overview of a NoC used to connect together communicating elements.

In the illustrated embodiment, NoC provides a communication between electronic devices.

NoC is thus an interconnection network providing efficient means to manage communication among the communicating elements, such as Central Possessing Unit (CPU), Memory (Mem), subsystems, . . . .

As illustrated, access to the NoC is made through network interfaces NI which support security for the communication system, by filtering requests to access the network at requested address.

The network interface NI is intended to provide communication between two separate interconnect systems namely, in the illustrated example, a network-on-chip and an on-chip bus.

Referring to FIG. 2, this network interface is used as enter and exit point of the NoC, to transfer data from a source electronic device to a destination electronic device connected to the NI through a on-chip bus or, generally speaking, to transfer data through the NoC.

However, it should be noted that the network interface can be used to allow communication between other types of interconnection systems and, in particular, it can be used with other on-chip protocols, namely the so-called AMBA, AXI, OCP, . . . protocols.

As it is known, data transmitted through the network on-chip and through the on-chip bus have differing formats, the NI being responsible for adapting the data from one format to another.

As a matter of fact, network on-chip is a communication architecture for systems on-chip, usually based on the concept of packet switching rather than circuit switching.

In on-chip bus, data are transmitted in the form of packets consisting in a set of cells that are not interruptible. For example, as indicated above, one channel may be used to transmit control data, another channel being provided to transfer the actual data to be transmitted. In a NoC context, the packets are split into basic units called flits (Flow Control Units), and comprise header containing the control data responsible for carrying all the information required for performing communication and, depending on the kind of operation performed, a payload containing actual information to be transmitted and a.

The network interface is thus intended to realize a conversion of packets according to the protocol supported by the on-chip bus into packets having the structure corresponding to the network on-chip concept. In addition, the network interface is intended to convert packets issued from the NoC into packets corresponding to the on-chip bus.

Beside, in order to reduce latency, and in particular due to the requested conversion of format necessary to transfer the data packets from the first electronic device to the second electronic device, the network interface provides a store and forward mechanism during transfer.

In other words, data packets are stored in memory means provided within the network interface, and data packets are read from the memory means after the packets have been stored.

However, the store and forward mechanism can be carried out on one packet basis or on a burst of packet basis, according to a value of a control parameter previously set during the network interface programming.

For example, the control parameter can be set to “0”, “1”, or “2”.

When the control parameter is set to “0”, the store and forward mechanism is not active. Accordingly, data, namely flits, issued from the network-on-chip or bus cells, issued from the on-chip bus, are transmitted as soon as some information is available in the memory.

When the control parameter is set to “1” or “2”, the store and forward mechanism is active and, before transferring the flits, issued from the network-on-chip, or the cells, issued from the on-chip bus, the network interface waits for an entire stream of packets is collected into the memory, unless the memory is full.

In other words, when the control parameter is set to “1”, the memory is read when it is determined that it is not empty and that a full packet has been previously stored in the memory.

Conversely, when the control parameter is set to “2”, the network interface waits for a plurality of packets, namely a burst of packets, have been previously stored in the memory.

As it will be appreciated, this store and forward mechanism can be used to transfer a stream of at least one data packet from one electronic device to another through a network interface.

The network-on-chip thus provides means for controlling the transfer of data in a bidirectional way.

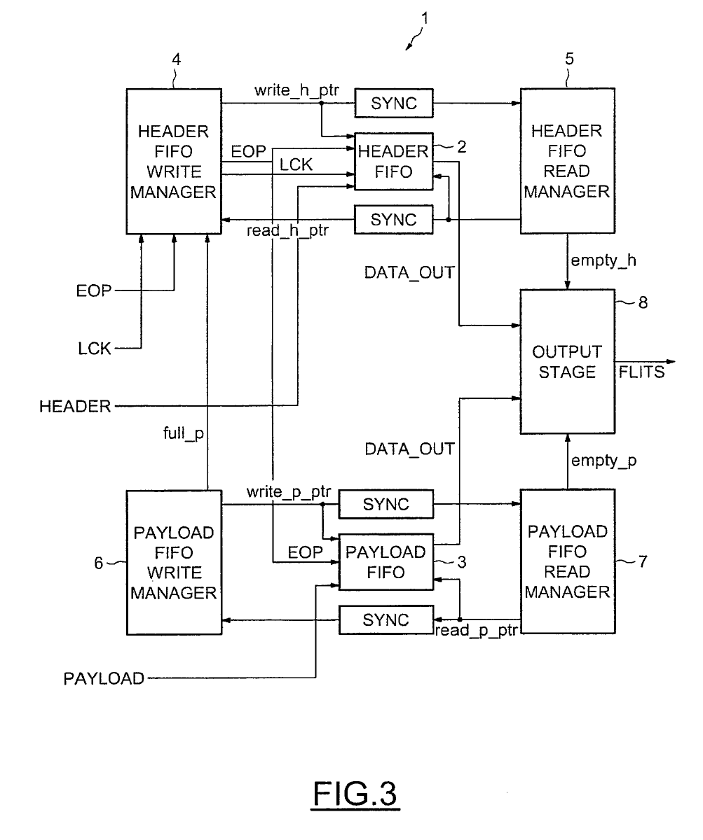

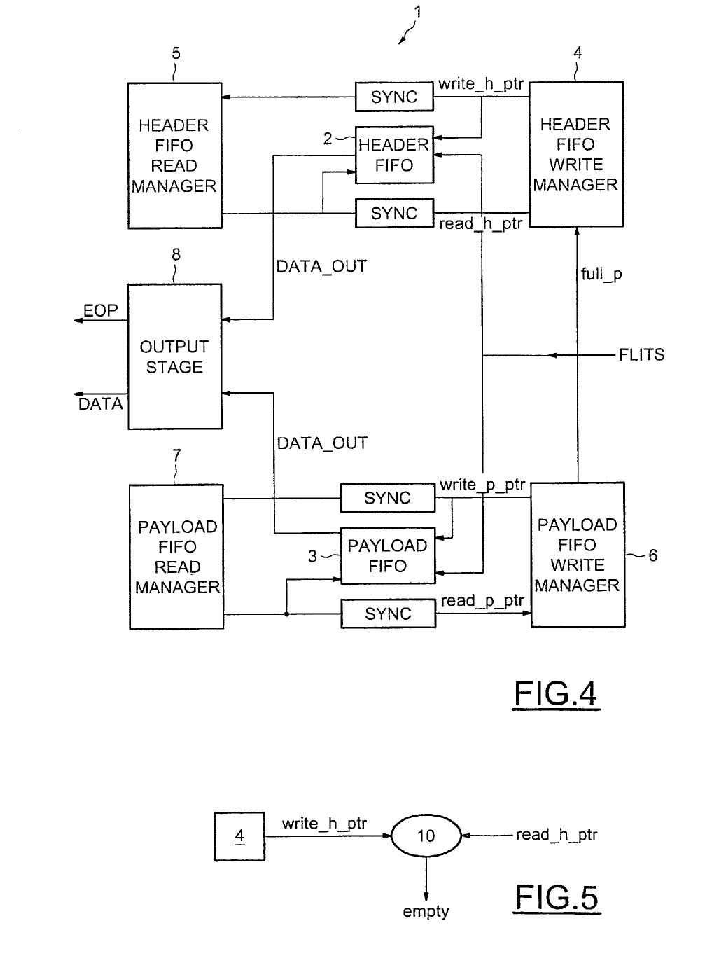

Although FIG. 3 illustrates the general organization of the network interface to control the packets stream following a request issued from a first device connected to the on-chip bus, for example a Central Processing Unit (CPU) requesting to access a memory, FIG. 4 illustrates the transfer of data according to a response path, namely from a second device, such as a memory to the CPU. However, it should be noted that elements of the request path and of the response path are provided in the same NI in the form of two parallel circuitries.

As far as the transfer of data is concerned, and in particular data conversion, the network interface comprises two stages having a substantially symmetrical structure illustrated in FIGS. 3 and 4, in which identical elements are denoted by the same references.

FIG. 3 illustrates a path of a request transmitted from a first device to access a second device to proceed with an operation such as read, store, write, load, . . . FIG. 4 concerns a path of a response transmitted from the second device to the first device in reply to the request previously transmitted.

Communication between the on-chip bus and the network interface may be based on a so-called request and grant process in which grant signals are transmitted to the on-chip bus in reply to a request to allow reception of data.

Beside, process used to transfer data between the network interface and the network-on-chip may be based on a credit based control process, in which “credits” are transmitted to the NI, said credits corresponding to a quantity of data that the NI is authorized to transmit. Upon receipt, the NI can transmit data to the NoC for so long as the credits last.

In both paths, conversion of data requires storage of data retrieved from the NI in memory means 1 for storing control data used to control data transfer and the actual data to be transferred.

According to the embodiment illustrated in FIGS. 3 and 4, storage means 1 comprise two memories 2 and 3.

For example, the memories 2 and 3 consist each in a first-in first-out memory (FIFO).

The first FIFO 2 is used to store packet header data for packets transferred in the network-on-chip, whereas FIFO 3 is used to store a packet payload data for the packets injected in or extracted from the NoC.

According to the request path, initiator transaction requests issued from the source electronic device to access the destination electronic device are retrieved by the network interface and are stored in the header FIFO 2 and payload FIFO 3, such that control data are stored in the header FIFO 2, whereas actual data to be transferred are stored in the payload FIFO 3.

However, it should be noted that data retrieved from a transaction issued from the on-chip bus are stored in the FIFO 2 and 3 in a packet shape. The saved packets are then forwarded to the NoC, split into flits.

As illustrated in FIG. 4, illustrating the response path, namely the flow of data in the NI in reply to a request issued from the on-chip bus (FIG. 3), packets split into flits issued from the network-on-chip and received by the network interface are stored in the FIFOs. After packet reconstruction, according to the on-chip bus protocol, data are transferred to the on-chip bus.

In view of the foregoing, the network interface comprises a header FIFO write manager 4 and a header FIFO read manager 5 intended respectively to write data in the header FIFO 2 and to read data from the header FIFO 2 using write and read pointers, respectively write_h_ptr and read_h_ptr.

Besides, the network interface comprises a payload FIFO write manager 6 and a payload FIFO read manager 7 intended, respectively, to control writing of payload within the payload FIFO 3 and to read payload data from the payload FIFO 3, using write and read pointers, respectively write_p_ptr and read_p_ptr.

On the write side, for each packet, according to the value of the control parameter, header is stored within the header FIFO 2, whereas payload is stored in the payload FIFO 3 at an address corresponding to the write pointers write_h_ptr and write_p_ptr.

As explained below, the header FIFO 1 write manager receives a flag signal EOP indicating an end of packet, a lock flag LCK, the value of which is intended to indicate an end of a packet stream. As a matter of fact, it should be noted that each packet of the data stream comprises an EOP flag set to a valid value at the end of the packet and a LCK flag indicating the last packet of the stream. Both EOP and LCK are then stored in the memory means. EOP flag is stored in the header or payload FIFO depending on the kind of transaction requested, while LCK flag is stored in the header.

Besides, an output stage 8 receiving empty signals, respectively empty_h and empty_p from the header FIFO read manager 5 and from the payload FIFO read manager 8 is used to retrieve data from the header FIFO 2 and the payload FIFO 3. According to the request path (FIG. 3) data are then transferred, split into flits to the destination electronic device. In the response path, the retrieved data are then forwarded to the on-chip bus.

In other words, when the header FIFO read manager and the payload FIFO read manager indicate to the output stage 8 that data are stored to the header FIFO and the payload FIFO, respectively, the output stage, constituted for example by a finite state machine, send a read request in order to retrieve data from the FIFOs 2 and 3.

As previously indicated, when the control parameter is set to “0”, the store and forward mechanism is not active. The header is written in the header FIFO and, when the header indicates that a payload is associated with a header, this payload is stored within the payload FIFO 3.

The write pointer write_h_ptr of the header FIFO 2 is immediately updated.

Conversely, when the control parameter is set to “1” or “2”, the store and forward mechanism is active per packet, or per burst of packet. The header is written but the write pointer is updated only when the last payload flit relative to this header has been stored in the payload FIFO 3, or when the payload FIFO is full.

In other words, the write_h_ptr pointer is updated when the header FIFO write manager receives the first flag EOP (FIG. 3) or receives the full signal full_p from the payload FIFO write manager 6.

On the read side, data are retrieved from the header FIFO 2 and from the payload FIFO 3 according to the value of the control parameter.

When the control parameter is set to “0” or “1”, the store and forward mechanism is not active or is active per packet. The header is read as soon as the comparison of the synchronized copy of the write pointer write_h_ptr and of the read pointer read_h_ptr indicates that the header FIFO is not empty.

Referring to FIG. 5, the header FIFO read manager thus comprises an empty manager, comprising comparing means 10 used to compare the write pointer write_h_ptr and the read pointer read_h_ptr to elaborate an empty flag empty_h.

Accordingly, the header is read as soon as the comparison between the pointers indicates that the header FIFO is not empty.

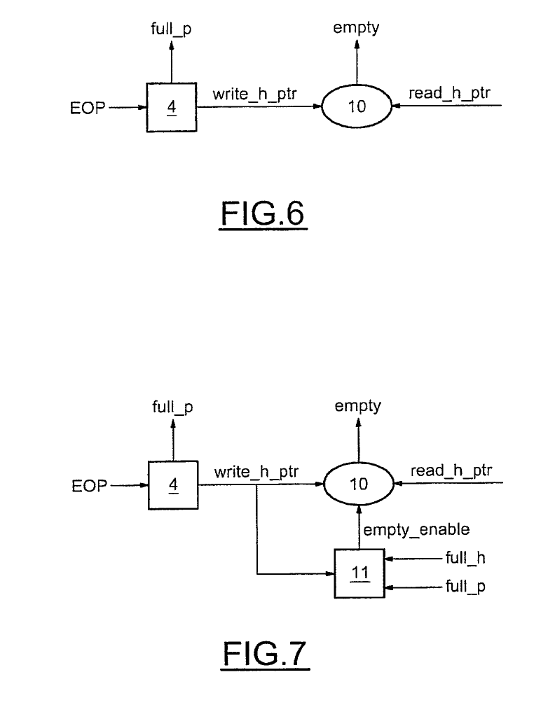

Referring to FIG. 6, when the control parameter is set to “1”, the write pointer is updated only when the complete packet has been stored in the header and payload FIFOs, unless the payload FIFO is full.

As illustrated, the header FIFO write manager 4 receives the end of packet flag EOP and the full flag full_p and updates the write pointer accordingly. The empty signal is elaborated, as previously indicated, by comparing the write and read pointers.

Referring now to FIG. 7, when the control parameter is set to “2”, the store and forward mechanism is active per burst of packets.

The header is read either when the last header of the stream of packets has been stored in the header FIFO or when either the header FIFO or the payload FIFO is full.

The empty signal is elaborated as previously indicated but the empty flag is disabled as long as the last packet of the stream of packets has not been stored in a memory.

It should be noted that as long as a full stream of data packets has not been transmitted to the network interface, a lock field LCK in the header is set to indicate that the last packet has not yet been transferred to the network interface.

Referring to FIG. 7, the write pointer write_h_ptr is updated as previously indicated from the full flag full_p and end of packet flag EOP, and thus the updated write pointer is transmitted to the empty manager 10.

Besides, a finite state machine 11 scans the header to check the value of the LCK field.

In addition, the finite state machine 11 receives the full flags, namely full_h and full_p to check whether the header FIFO 2 or the payload FIFO 3 is full.

When the finite state machine 11 has determined that the whole stream of packets has been stored within the memory or that either the header FIFO or the payload FIFO is full, an empty enable flag empty_enable is set to authorize the empty manager 10 to generate the empty flag flag_empty.

To implement the generation of the empty enable flag, a dummy read of the header is carried out using an auxiliary read pointer rd_ptr_aux in order to determine the value of the lock field LCK.

The write pointer is updated in a per packet basis. However, this update is not used immediately to produce the empty flag. It is used to indicate to the logic circuitry that manages the auxiliary read pointer that a new packet belonging to the current stream has been stored. It means that packets of stream are examined on a per-packet basis. Each header is examined once the complete packet is received. When the LCK flag is finally found equal to 1, this information is used to pass the empty signal to the output stage 8 that starts to read packets from the first packet of the current stream.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
transferring a stream of at least one data packet between a first electronic device and a second electronic device through a network-on-chip;
storing the at least one data packet in a memory, wherein the at least one packet is provided through a network interface; and
transferring the at least one data packet from the memory to the second device, wherein the at least one packet is transferred from the memory after a quantity of packets is stored in the memory, the quantity of packets being determined according to a value of a control parameter.

2. The method according to claim 1, wherein packets are transferred when the memory is full.

3. The method according to claim 1, further comprising comparing a write pointer and a read pointer in the memory and transferring the at least one packet when the result of this comparison indicates that the at least one packet has been stored in the memory.

4. The method according to claim 3, wherein the at least one packet comprises a header and a payload, wherein the header is stored in a header memory and the payload is stored in a payload memory.

5. The method according to claim 4, wherein the value of a header memory write pointer is updated when the quantity of packets have been stored in the memory.

6. The method according to claim 5, further comprising:
transferring a stream comprising at least one data packet, wherein the value of the header memory write pointer is updated when the last data of the at least one data packet has been stored in the memory.

7. The method according to claim 6, further comprising:
detecting a first flag in the packet indicating the last data of the packet.

8. The method according to claim 5, further comprising:
transferring a stream of at least two packets, wherein the value of the header memory write pointer is updated for each packet to check, wherein the value of a second flag indicates the last packet on an end of packet stream of the stream of data packets.

9. The method according to claim 8, further comprising:
accessing the header memory for scanning each packet header stored in the memory using an auxiliary read pointer updated after each packet storage to detect, in the packet header, the second flag, and authorizing the packets transferring when the memory are not empty.

10. The method according to claim 9,
further comprising detecting a flag in each header indicating the presence of a payload in a packet.

11. The method according to claim 10, wherein the header memory write pointer is updated when the second memory is full.

12. Method according to claim 11, wherein the data packets are transferred when the first or the second memory is full.

13. A system, comprising:
a device for transferring a stream of at least one data packet between a first electronic device and a second electronic device through a network-on-chip; and
a memory, wherein the memory stores at least one data packet and transfers the at least one data packet after a quantity of packets is stored in the memory, wherein the quantity of packets is determined according to a value of a control parameter.

14. The system of claim 13, wherein the memory comprises a header memory for storing a header of each packet comprising control data for controlling data transfer, and a payload memory for storing a payload comprising actual data to be transferred.

15. The system of claim 14, further comprising a first flag in the memory indicating the last data of the packet and for updating a write pointer for the memory after detection of the first flag.

16. The system of claim 15, wherein the device detects a full status of the second memory and updates the write pointer after detection of the full status.

17. The system of claim 16, wherein the device compares the write pointer and a read pointer for the memory, and the device reads the memory when the result of the comparison indicates that packets have been stored in the memory.

18. The system of claim 15, wherein the device checks the value of a second flag indicating the last packet of the stream of data packets, and wherein the device reads the memory when the last packet is stored in the memory.

19. The system of claim 18, wherein the device detects a full status of the first and second memories, and wherein the device reads the memory after detection of full status of either the first memory or the second memory.

20. The system of claim 13, further comprising:
a network-on-chip and a network interface for transferring a stream of at least one data packet between a first electronic device and a second electronic device through the network-on-chip.
